(19) United States
(12) Patent Application Publication
(10) Pub. No.: US 2009/0055199 A1
(43) Pub. Date: Feb. 26, 2009

(54) Customer Recommendation System

(75) Inventor: Anthony Paul Yusuf, London (GB)

Correspondence Address: RISSMAN JOBSE HENDRICKS & OLIVERIO, LLP, 100 Cambridge Street, Suite 2101, BOSTON, MA, 02114, US

(73) Assignee: Setup Ventures Licensing Limited, St. Helier, Jersey (GB)

(21) Appl. No.: 11/719,700

(22) PCT Filed: Nov. 17, 2005
(86) PCT No.: PCT/GB2005/004456

§ 371 Date: Jul. 19, 2007

(30) Foreign Application Priority Data
Nov. 19, 2004 (GB) 0425557.6

(51) Int. Cl. G06Q 30/00

(52) U.S. Cl. 705/1

(57) ABSTRACT

A system for generating for a client at least one indication of a food product to be purchased, the system comprising: data entry means for entering at least one product reference associated with a purchased product; first storage means for storing said at least one product reference in association with an identifier; second storage means for storing a plurality of product references in association with respective food values; third storage means for holding a recommended total food value; terminal means coupled to the first storage means for receiving the identifier; a recommendation unit for comparing the food value of the purchased product with said recommended total food value, said recommendation unit being arranged to select from said plurality of product references at least one product based on the result of said comparison, whereby said indication is generated for the client.

The present application relates to a computer system for automatically generating for a client a recommendation for a food product and in particular to a system for recommending future food product purchases to a customer based on one or more previous purchases.

Nowadays consumers tend to be inundated with information regarding what they should and should not eat. For example consumers are told that they should avoid salt and fatty foods, and ensure that they receive a good balance of vitamins, minerals and iron. Higher incidences of obesity, heart disease and cancer may be attributed to poor diet among consumers, and consumers are becoming more aware of their dietary requirements and the effect on their health. However, for the consumer who wishes to purchase food for example a sandwich at lunch time, maintaining a daily balanced diet can be an extremely difficult proposition. Depending on the breakfast that the consumer had that morning, a low fat lunch may be required in order to maintain the daily balance, or alternatively one or more portions of fruit and vegetables may required to ensure that the consumer has consumed the recommended quantity. The consumer may have already consumed their recommended quantities of sugar and salt for the day for example but may require more fat intake in order to ensure that their fat intake for the day is correct. It can be very difficult for a consumer to make informed choices when making food purchases. There is a need for a system capable of simplifying these decisions for a consumer, and generating an indication of menu options that will provide the user with a daily balanced diet (DBD).

According to one aspect of the present invention, a system for generating for a client at least one indication of a food product to be purchased is provided. The system comprises data entry means for entering at least one product reference associated with a purchased product, first storage means for storing said at least one product reference in association with an identifier, second storage means for storing a plurality of product references in association with respective food values, third storage means for holding a recommended total food value, terminal means coupled to the first storage means for receiving the identifier, a recommendation unit for comparing the food value of the purchased product with the recommended total food value, the recommendation unit being arranged to select from the plurality of product references at least one product based on the result of the comparison, whereby the indication is generated for the client.

Preferably, the recommendation unit comprises means for receiving the at least one product reference from said first storage means, means for reading from the second storage means food values associated with said product reference, and means for reading from said third storage means the recommended total food value. The recommendation unit also preferably comprises means for determining the difference between the food value of the purchased product and said recommended total food value and means for reading from said second storage means at least one product with an associated food value less than or equal to said difference.

Preferably the identifier is associated with the purchase of one or more products, or alternatively with the client. The identifier may also be associated with a client account, and the system may comprise storage means for storing personal information associated with the client.

Preferably the food products are organised in a set of categories, each category including food products of a food type. The food type is preferably indicated by colour.

The food value preferably indicates a nutritional content of the food.

Preferably the recommended total food value in the third storage means is associated with a client type.

Preferably the system comprises display means for displaying the indication. For example, this could be a computer monitor or the like.

Preferably the system comprises a computer network having server means including said recommendation unit, and at least one store terminal connected to the server means, the store terminal including the data entry means. Preferably the terminal means comprises a client terminal remote from the store terminal and connected to the server means.

According to another aspect of the present invention, a system for generating for a client at least one indication of a food product to be purchased is provided. The system comprises data entry means for receiving a food type associated with a purchased product, said food type representing a food value, storage means for holding a recommended total food value, a calculation unit for comparing the food value of the purchased product with the recommended total food value, the calculation unit being arranged to indicate at least one food type based on the comparison and printing means for printing said at least one food type on a receipt for the client.

According to another aspect of the present invention, server circuitry is provided for generating for a client at least one indication of a food product to be purchased. The server circuitry comprises means for receiving at least one product reference associated with a purchased product, first storage means for storing said at least one product reference in association with an identifier provided to the client, second storage means for storing a plurality of product references in association with respective food values, third storage means for holding a recommended total food value, receiving means for receiving an identifier from a remote terminal, and for accessing the purchased product associated with that identifier, means for comparing the food value of the purchased product with the recommended total food value and selecting from said plurality of product references at least one product based on the result of said comparison, thereby generating said indication for the client.

According to yet another aspect of the present invention, a terminal is provided for providing to a client at least one indication of a food product to be purchased. The terminal comprises input means for inputting an identifier provided to said client, transmitting means for transmitting the identifier to server circuitry, and receiving means for receiving from the server circuitry the indication and providing the indication to the client, wherein the server circuitry is operable to receive the identifier, determine at least one product reference associated with the identifier, determine a food value associated with the product reference, compare said food value with a recommended total food value, and based on said comparison select from a plurality of product references at least one product, and transmit the indication indicating product.

According to another aspect of the present invention, a shop terminal is provided for transmitting product references to server circuitry such that the server circuitry is able to generate for a client at least one indication of a food product to be purchased. The shop terminal comprises data entry means for entering at least one product reference associated with a purchased product and means for transmitting the at least one product reference to the server circuitry. The server circuitry is operable to store the at least one product reference in association with an identifier, determine a food value associated with the at least one product reference, compare the food value with a recommended total food value, and based on this comparison select from a plurality of product references at least one product, whereby the indication is generated for the client.

According to yet another aspect of the present invention, a method for generating for a client at least one indication of a food product to be purchased is provided. The method comprises the steps of, at a first location, receiving at least one product reference associated with a purchased product and storing the product reference in association with an identifier, and at a second location receiving the identifier from terminal means, determining a food value associated with the purchased product, determining a recommended total food value, comparing the food value with the recommended total food value, and selecting from said plurality of product references at least one product based on the result of said comparison, thereby generating the indication for the client.

According to yet another aspect of the present invention, a method is provided for generating for a client at least one indication of a food product to be purchased. The method comprises the steps of inputting an identifier at a client terminal, transmitting the identifier to server circuitry and receiving from the server circuitry the at least one indication, wherein said server circuitry is capable of receiving the identifier, determining at least one product reference associated with the identifier, determining a food value associated with said at least one product reference, comparing the food value with a recommended total food value, and based on this comparison selecting from a plurality of product references at least one product and transmitting the indication indicating the at least one product.

According to yet another aspect of the present invention, a method for generating for a client at least one indication of a food product to be purchased is provided, the method comprising the steps of inputting at least one product reference associated with a purchased product and transmitting the product reference to server circuitry, wherein said server circuitry is capable of storing the product reference(s) in association with an identifier, determining a food value associated with the product reference(s), comparing the food value with a recommended total food value, and based on this comparison selecting from a plurality of product references at least one product, whereby the indication is generated for the client.

According to another embodiment of the present invention a system is provided for generating for a client at least one indication of a food product to be purchased, the system comprising first storage means for storing a plurality of product references in association with respective food values; second storage means for holding a plurality of recommended total food value; terminal means for receiving preference and/or condition data relating to said client and transmitting said preference and/or condition data to a recommendation unit; said recommendation unit arranged to determine a recommended total food value associated with said preference and/or condition data and compare said recommended total food value with food values associated with said product references, said recommendation unit being arranged to select from said plurality of product references at least one product based on the result of said comparison, whereby said indication is generated for the client.

According to yet another embodiment of the present invention a terminal is provided for providing a client at least one indication of a food product to be purchased, the terminal comprising input means for inputting preference and/or condition data relating to said client; transmitting means for transmitting said preference and/or condition data to server circuitry; and receiving means for receiving from said server circuitry at least one indication and providing said indication to the client, wherein said server circuitry is operable to receive said preference and/or condition data; determine a recommended total food value associated with said preference and/or condition data; compare said recommended total food value with food value associated with a product, and based on said compensation select from a plurality of product references at least one product; and transmit said indication indicating said at least one product.

According to another aspect of the present invention a method for generating for a client at least one indication of a food product to be purchased, the method comprising the steps of inputting at least one preference or condition associated with said client; and transmitting said at least one preference or condition to server circuitry, wherein said server circuitry is capable of determining a recommended total food value associated with said preference or condition; determining at least one food value associated with said at least one product reference; comparing said recommended total food value with said at least one food value, and based on said comparison selecting from a plurality of product references at least one product, whereby said indication is generated for the client.

For a better understanding of the present invention and to show how the same may be carried into effect, embodiments of the invention will now be described by way of example with reference to the accompanying drawings, in which:

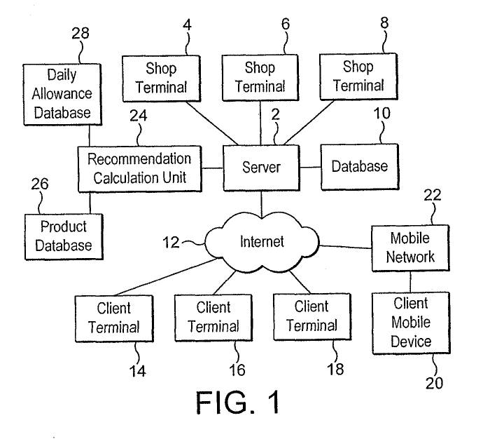

FIG. 1 illustrates an overview of the system according to an embodiment of the present invention;

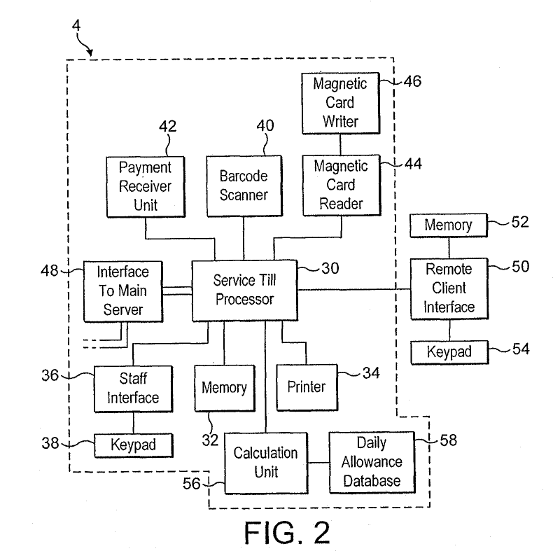

FIG. 2 illustrates a shop terminal and remote client interface according to an embodiment of the present invention;

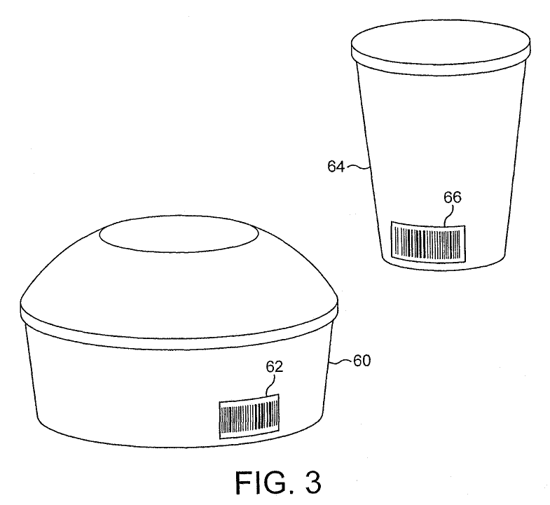

FIG. 3 illustrates product packaging according to one embodiment;

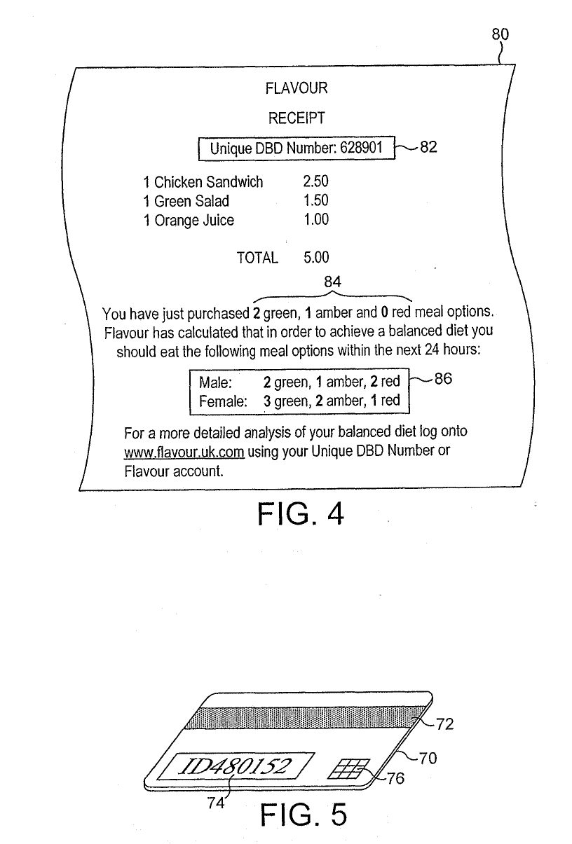

FIG. 4 illustrates a client receipt according to one embodiment; and

FIG. 5 illustrates a client identification card according to an embodiment;

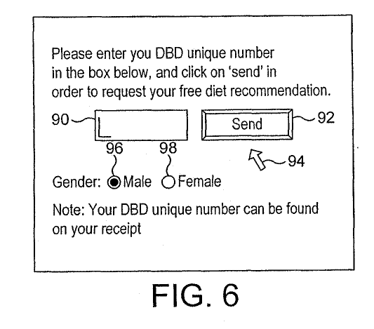

FIG. 6 illustrates a webpage for requesting a recommendation according to one embodiment;

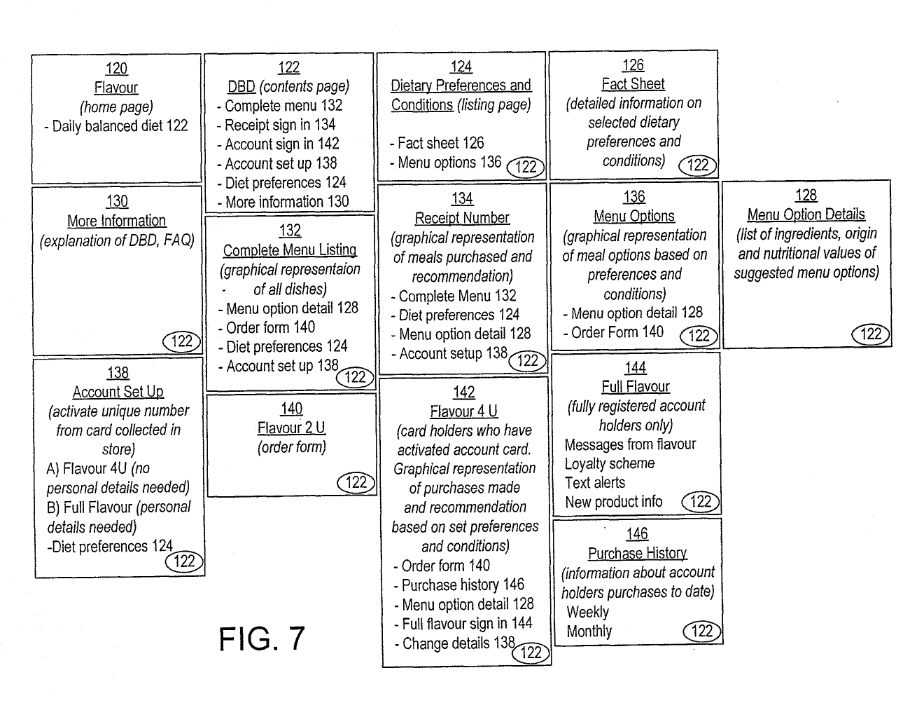

FIG. 7 illustrates a plan of a website interface according to one embodiment;

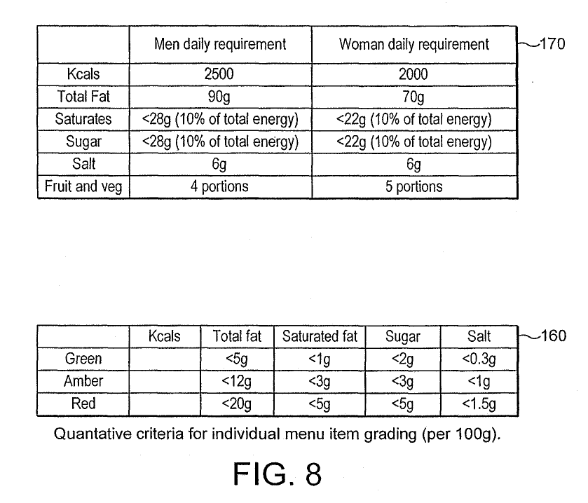

FIG. 8 shows examples of daily nutritional requirements for men and women and the criteria for green, amber and red products;

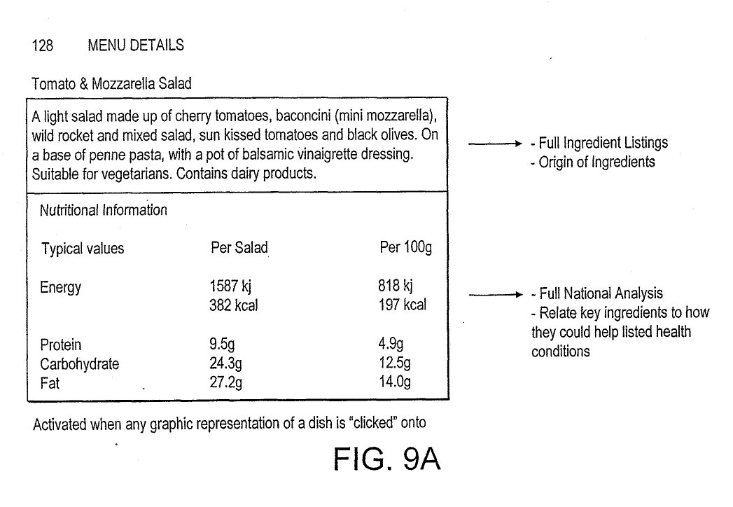

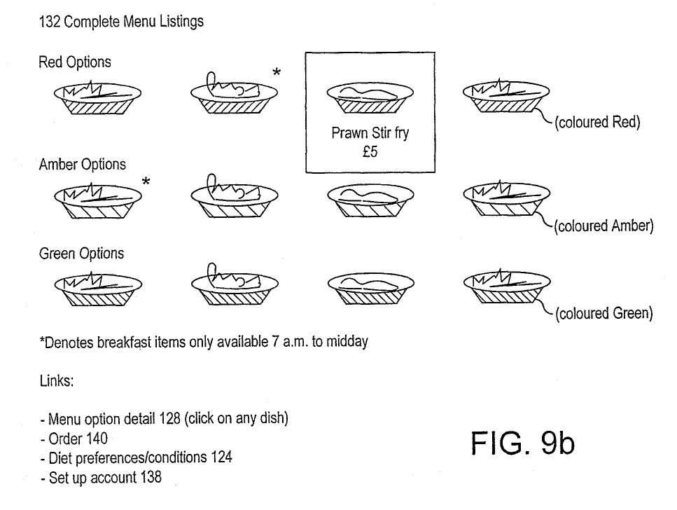

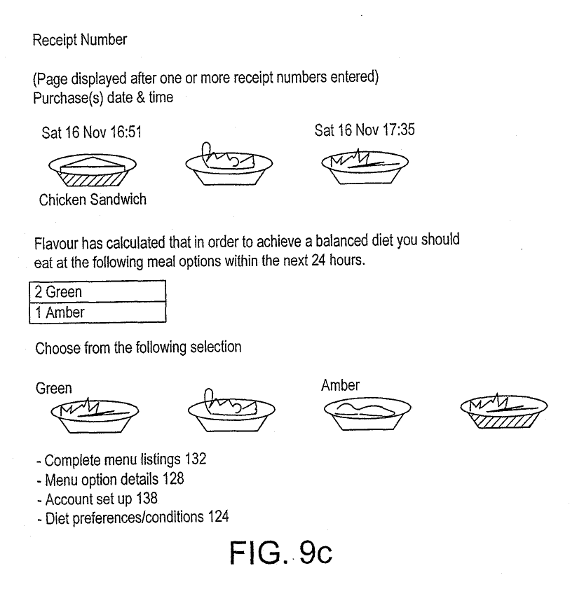

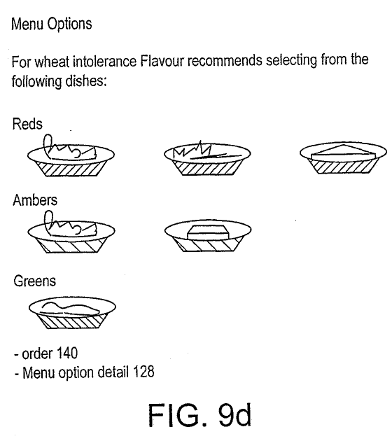

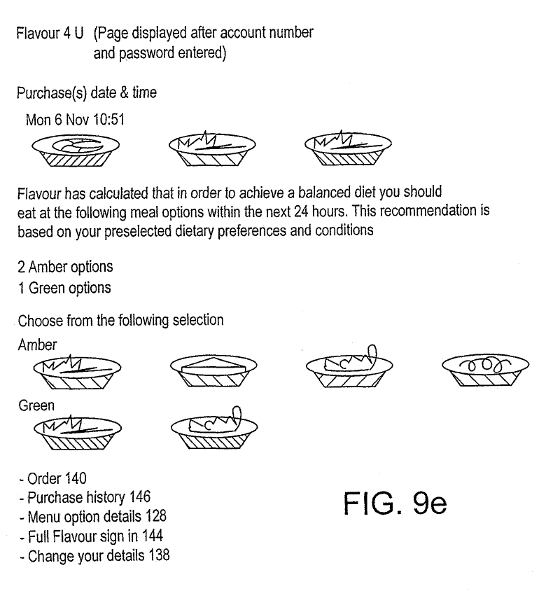

FIGS. 9a to 9e show examples of pages from the website interface; and

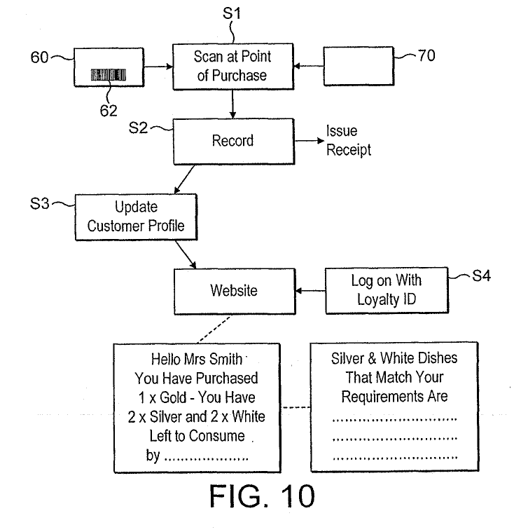

FIG. 10 is a flow chart showing operation of one embodiment of the present invention.

A traffic light diet system has been proposed whereby food products are colour coded in packaging coloured either green, amber or red. According to one system, green products might represent very low fat products such as fruit and vegetables which should be eaten relatively frequently during the day, amber products might be low fat items which may be eaten for those trying to lose weight and red may represent products with relatively high fat levels and/or high sugar levels, which should only be eaten as a treat occasionally. For example, red products may include a certain quantity of saturated fat such that if too many of these products are eaten in one day the total quantity of saturated fat would be unhealthy. The traffic light system aims, among other things, to provide a strict guide that is simple to use for busy people with stressful lives and little free time who wish to eat takeaway food.

FIG. 8 shows an example in accordance with an embodiment of the invention of how products may be categorised into green, amber and red products. In alternative embodiments products could be categorised into groups distinguished by other means such as other colours, or letters for example. Table 170 shows the daily requirements of energy, in kilo calories, total fat, saturates, sugar and salt. For saturates and salt, the values given are maximum levels. The table also shows the recommended number of daily portions of fruit and vegetables for men and women Using these values, it may be determined what quantities individual items should contain in order to be classified as green, amber and red. An example is shown in Table 160, which shows maximum values of total fat, saturated fat, sugar and salt in green, amber and red products. This table also shows the recommended number of daily portions of fruit and vegetables for males and females. Using this table, products can be categorised as either green, amber or red. In alternative methods, other factors could be taken into account when categorising products, such as the vitamin content, carbohydrate content, fibre content, protein content or any other measurable food property.

According to the system described herein, a daily recommended diet for a male includes eating for example four green products, two amber products and two red products in one day. For a woman, the numbers might be five green products, two amber products and one red. These numbers are based on the maximum total fat, saturated fat, sugar and salt levels given in Table 160 for green, amber and red products. If these values were different, then a different number of each product might be recommended for males and females. These numbers of green, amber and red products for men and women would provide the right total fat and saturated fat intake for a particular day, as well as the recommended quantities of fruit and vegetables, sugar and salt. It will be the case that most green products will be fruit or vegetables, due to the very low fat content requirement for green products, and therefore four green products for a male and five green products for a female would more than likely satisfy the daily recommended number of fruit and vegetable portions.

In another embodiment, products can be colour coded white, silver and gold. Once again, the grading is dependent upon a level of fat, saturated fat, salt and sugar within each dish. The colour coding can be illustrated on the product label by way of background colour to the label. According to this embodiment, the set prescription of dishes per day for men and women can be such that if the prescription is followed, then the consumer will not exceed the Government recommended intake of fat, saturated fat, salt and sugar within a 24 hour period. For men, the number of products in this embodiment is two gold, two silver and two white, while for women it is one gold, two silver and three white.

Given further information on the consumer a more advanced recommendation system can be devised. This further information may include details of the past consumption by the consumer, any medical conditions suffered by the consumer, consumer preferences, the weight, age and gender of the consumer and the lifestyle led by the consumer.

The system of the described embodiment allows a client to enter one of a chain of food outlets and be presented with recommendations for purchases both prior to and after purchasing a food product. Recommendations are given for meals in the following 24 hours after a food purchase, however in alternative embodiments, recommendations could be given for meals during a different time period after a purchase, for example a week, or just a few hours. A client may also be provided with recommendations via the internet, or on their mobile phone, and the system allows recommendations to be accurately tailored to each client. Preferably a client will decide to purchase all their meals for a certain period from this particular chain, in order to ensure a balanced diet for that entire period. However, clients would still benefit from the present system if only a few purchases a day were made.

An overview of a system according to one possible embodiment of the present invention is shown in FIG. 1. Each food outlet in a chain includes a shop terminal, and these are labelled 4, 6 and 8 in FIG. 1. A shop terminal is preferably staffed by a member of the staff in the food outlet, and is used for taking payment from a client and also for recording and transmitting records of client purchases and associating them with a particular client or receipt number. The shop terminal includes a service till processor, barcode scanner for scanning barcodes of products being purchased, a printer for printing receipts and a magnetic card reader for reading magnetic cards presented by the consumer, and these features along with further features of the shop terminals will be described hereinafter in relation to FIG. 2.

Each of the shop terminals 4, 6 and 8 is connected to a server 2. Server 2 maintains a database 10, which is stored in a memory. Database 10 stores client records as well as the details of particular purchases that have been made by a client. Server 2 is also connected to the Internet 12. In their homes or workplaces, clients who purchase items from food outlets preferably have client computers, and these are labelled in FIG. 1 as client terminals 14, 16 and 18. The client terminals have access to the Internet 12, and to server 2 via the Internet. One or more clients may also have a mobile device labelled 20 in FIG. 1. The mobile device may have access to the Internet via mobile network 22.

Server 2 is also connected to a recommendation calculation unit 24. The recommendation calculation unit's role is to calculate recommendations for future purchases by a client. The recommendation calculation unit is connected to a product database 26 which stores details of all food and drink products sold in the food outlets which are part of the traffic light system. Details include whether the product is a green, amber or red product. The product database may also store further nutritional information, for example quantities of certain vitamins, minerals, iron, fat, GI (glycemic index), fibre, omega 3 fatty acids, isoflavones, carbohydrates and protein.

The recommendation calculation unit 24 is also connected to a daily allowance database 28. This database stores records of the recommended daily allowances, for example the recommended daily numbers of green, amber and red products for men and women. This database may also store recommended daily allowances for a range of nutritional properties of products, for males and females. The recommendations relate to, for example, daily quantities of certain vitamins, minerals, iron, fat, GI, fibre, omega 3 fatty acids, isoflavones, carbohydrate and protein.

The daily allowances in the database may include not only recommended allowances for average men and women, but also allowances for men and women with a range of preferences or medical conditions. These preferences and conditions can be selected by the client. For example, the database includes separate daily recommended allowances for those preferring low fat, low GI, high fibre, products rich in omega 3 fatty acids, products rich in isoflavones, low carbohydrate or high protein. The database also separately lists the daily allowances recommended for people with certain medical conditions such as for example those with weight problems, IBS (irritable bowl syndrome), diabetes, PMS (premenstrual syndrome), Menopause, Stress, wheat/dairy allergy.

As shown in FIG. 1, the recommendation calculation unit 24 and databases 10, 26 and 28 are preferably implemented by circuitry located centrally at the server. In alternative embodiments, parts of this circuitry, such as databases, or the recommendation calculation unit, may be located elsewhere, for example at a shop terminal, or otherwise remote from the server itself.

All of the connections shown in FIG. 1, for example between each shop terminal and the server 2, between server 2 and the internet, between the internet and the client terminals and between the server 2, database 10 and recommendation calculation unit 24 are by way of a communications path, allowing the transfer of electronic data. Each connection could be wired, or alternatively some could be wireless connections. In the case of wireless connections, known modulation techniques could be used to modulate the electronic data onto carrier signals to be transmitted and received by transmitting and receiving antennas.

FIG. 2 shows the shop terminal 4 of FIG. 1 in more detail as well as a remote client interface. The system of FIG. 2 is aimed at showing one embodiment of the present invention, however it would be obvious to the skilled person that there are many alternatives, for example providing separate payment receiving means not connected to the processor. Other shop terminals in the chain of outlets, such as 6 and 8 shown in FIG. 1 would also have similar circuitry to that shown in FIG. 2.

The shop terminal preferably comprises a service till processor 30, which controls operation of the hardware in the shop terminal, and reads and writes to/from memory 32. The service till processor 30 is connected via a communication path to the memory 32, printer 34, a staff interface 36 with keypad 38, a barcode scanner 40, payment receiver unit 42, magnetic card reader 44 and magnetic card writer 46, an interface 48 to the main server 2, and a calculation unit 56 shown in FIG. 1. The service till processor 30 is thereby able to transfer electronic data via these communications paths to any of the connected hardware devices.

Service till processor 30 is also connected to a remote customer interface 50. The remote customer interface provides clients access to recommendations whilst within the store. The interface includes a display screen, such as an LCD (liquid crystal display) and is connected via a communications path to a memory 52 and keypad 54. As will be explained in more detail herein after, in alternative embodiments the remote client interface 50 could be independent of the service till processor, without a connection to it. In this case it would have its own connection to server 2, via its own interface.

According to the current embodiment, the shop terminal also includes a calculation unit 56, which is connected to a memory storing a daily allowance database 58. The daily allowance database 58 may be identical to the daily allowance database 28 of FIG. 1, but in the present embodiment it is a simplified database containing only the recommended daily numbers of green, amber and red products for men and women. The calculation unit 56 and allowance database 58 are optional in the shop terminals, as the equivalent hardware shown in FIG. 1 associated with the main server may be called upon to provide recommendations, as will be described later herein.

FIG. 3 shows the typical packaging of products on sale in one of the food outlets. Food packaging will be coloured either green, amber or red to indicate the type and nature of the product being sold. Alternatively however, food products could be labelled green, amber or red to indicate the type. The purpose of the coloured labelling or packaging is to indicate to a consumer the category of food they are purchasing. All food products in the outlets may be colour coded in this way, including snacks and drinks. In the case of some drinks with limited nutritional content such as tea, these items could be excluded from the colour coding system, or could count as a half green product for example.

FIG. 3 shows packaging 60 which is for a food product. The packaging 60 for food products in the food outlet will be coloured green, amber or red, depending on the food product, and will include a barcode 62. FIG. 3 also shows drinks packaging 64 which will also be coloured green, amber or red, and includes a barcode 66. Barcodes 62 and 66 include coded information regarding the type and price of the product, and also a unique product ID which distinguishes this product from other products. The barcode may also include information as to whether the product is green, amber or red, however this information is preferably determined from the unique product ID as will be explained below. Although the packaging has been shown with barcodes 62 and 66, in alternative embodiments other distinguishing means could be used on the packaging, for example a radio frequency identification tag (RF tag) storing information as to the cost and type of the product being sold.

FIG. 4 show a customer receipt 80 with DBD (daily balanced diet) Unique number 82. The receipt includes information relating to the products purchased, and an indication of the colours for the products purchased, which is labelled 84. The receipt also includes a recommendation, labelled 86, for the number of products of each colour that a client should eat in the next 24 hours.

FIG. 5 shows a customer identification card 70, with magnetic strip 72, ID number 74, and optional microchip 76. The receipt 80 and ID card 70 relate to two alternative embodiments of the present invention which can be implemented individually, but which are preferably used in parallel in the same system. Examples of the operation of the present invention in relation to the receipt 80 and the ID card 70 will now be described with reference to FIGS. 1, 2, 3, 4 and 5.

A client entering one of the food outlets may decide to purchase, for example, a sandwich and a green salad, each individually packaged in separate packages 60 each with a barcode 62. The packaging 60 for a chicken sandwich might be coloured amber indicating that it is a low fat product. The packaging for the green salad may be green, indicating that this product is for example fruit or vegetable. The client also decides to buy an orange juice, packaged in a cup 64 coloured green, with barcode 66. The client will take these items to a checkout till, which comprises shop terminal 4 of FIG. 2 with till processor 30.

A staff member will be ready to serve the client. The staff member will pass each of the products to be purchased by the client under the barcode scanner 40, such that the barcodes on each item can be read and the data inputted to service till processor 30. The data read from the bar code will be in coded form, and will be decoded by the barcode scanner such that the stored data can be determined. In particular, the unique product ID will be read from each product and provided to the service till processor 30. Service till processor 30, will then refer to memory 32, via the communication path, to determine the nature and price of each item. Memory 32 stores a database containing all of the products for sale in the food outlet. Associated with each product in the database is information as to whether the product is green, amber or red, and also a unique ID for each product. Service till processor 30 will search the memory 32 for products with the same electronic data defining the unique product ids read from the barcodes. In this way, the service till processor 30 may determine at least the cost of each item, and the colour. As described above, some of this information could alternatively be encoded in the barcode, in which case accessing the memory for this information may not be necessary.

The database in memory 32 may be a copy of certain fields from the central product database 26 of FIG. 1. According to the present embodiment of the present invention, database 32 would not need a copy of all of the nutritional content of each product, but does need the colour and cost of each item. Database 32 may be updated periodically with any updates to the central database 26, via interface 48.

The service till processor 30 will then perform a number of functions. Firstly, processor 30 will sum the costs of the individual products, and indicate to the staff member via the staff interface 36, which could be a screen in this case, the total cost of the purchase. The staff member will request payment from the client, and will enter the payment method using keypad 38. Payment receiving unit 42 may be a credit card reader, or cash register, or both, and will be used by the staff member to take payment.

Service till processor 30 will also assign the purchase a unique daily balanced diet (DBD) number, which uniquely identifies this particular purchase. This number may be selected from a pool of available reference numbers that are available for that particular service till to assign. It is important that the same unique DBD number is not assigned to more than one purchase during a certain period, and therefore preferably the service till processor 30 will assign numbers within a certain range, and a counter will be used to generate different numbers in binary form within the range. A record of this purchase, including the DBD unique number in binary form and product ID in binary form for each of the items purchased is then written to and stored in memory 32. The time of the purchase is also recorded, and stored in memory. The time can be determined from the system clock, or could be requested from server 2.

The electronic data representing the DBD unique number and the product ids of this purchase will also be transmitted to the main server 2, via the interface 48. The connection between the interface 48 and the till processor is preferably wired. This information may be transmitted directly when the purchase has been paid for, or alternatively the server 2 shown in FIG. 1 may from time to time request information regarding recent purchases from the service till processor 30 and the service till processors in other store terminals. In the latter case the details stored into that memory 32 may be returned to the main server.

Next it is necessary to generate an indication to the client of further food products that should be purchased in the next 24 hours in order to eat the recommended number of green, amber and red products. This indication will be provided on the clients receipt. In order to do this, the service till processor will transmit electronic data representing the number of each green, amber and red food and drink product purchased to the calculation unit 56, via a communication path. In the present example, the electronic data will indicate that 2 green products and 1 amber product have been purchased. Calculation unit 56 will then refer to the daily allowance database 58, in order to determine the recommended daily allowances of green, amber and red products. As the gender of the client is unknown, recommendations for both men and women will be returned. However, in alternative embodiments, the member of staff could enter the gender information using keypad 38, and this information could also be passed to the calculation unit 56, thereby personalising the recommendation. The information relating to the recommended daily allowance will be stored in electronic form in the memory, and read form the memory to the calculation unit in this form.

Calculation unit 56 will then compare the electronic data representing the numbers of green, amber and red products purchased to the electronic data representing the recommended daily values for men for each colour, and repeat the comparison for women. For men, the recommended number is 4 green products, and this will be compared to the number of green products purchased which is two. The result would be that a further two green products are required to satisfy the daily recommended quantity. The recommendation unit will therefore return, in electronic form, the value of two greens to the service till processor 30, indicating that for a man a further 2 green products should be purchased. The same comparison is performed for amber and red products, for men and women, giving a total of six results being returned to the service till processor. Alternatively, the member of staff at the service till could indicate via interface 36 and keypad 38 that the client is male or female and in this case only the relevant calculation would need to be performed.

The service till processor 30 will receive the electronic data representing the results of the comparisons, and then generate the receipt as shown in FIG. 4. Printer 32 prints the receipt, and is controlled by processor 30 via the communication path between the printer and processor. The receipt includes the number of green, amber and red products purchased, indicated at 84, and the recommendation for future purchases in the next 24 hours, indicated at 86. The receipt also indicates the daily balanced diet unique number 628901, labelled 82, which has been assigned to this purchase, so that the client has a record of this number. Although the recommendation is printed on the till receipt in this embodiment, in other embodiments the recommendation could be printed on a different receipt to the till receipt, or on a label that could be stuck to a purchased product for example.

It should be noted that this embodiment of the present invention does not require the magnetic card reader and writer shown in FIG. 2.

In alternative embodiments, the recommendation unit 24 shown in FIG. 1 could be called upon to generate the future product purchase recommendation shown on the receipt. In this case, the recommendation unit 56 and daily allowance database 58 in FIG. 2 would not be necessary. Instead, the unique product ids of products purchased would be sent to recommendation unit 24 via interface 48, and server 2. The recommendation calculation unit 24 would then refer to the product database 26 to determine the numbers of green, amber and red products purchased, and would operate in the same way as recommended calculation unit 56 in order to generate the recommendation. This would then be returned to the service till processor 30 to be printed on the clients receipt.

The DBD unique number 82 allows the client access to a number of services. Upon returning to their office or home, the client may have access to a computer terminal. Such computer terminals are labelled 14, 16 and 18 in FIG. 1. From a computer terminal with access to the Internet, the client may access a web page associated with the chain of food outlets. FIG. 7 shows an example of a plan for a website suitable for interfacing with a client. Each box in FIG. 7 relates to a page in the website, and in each box a number of other pages are listed to which a user may be linked to directly from the present page, for example by clicking a box with the mouse cursor. The plan will be described in more detail below, however the page labelled 134 is a receipt number page that allows a client to input their receipt number and request a recommendation, as will now be explained.

As is known in the art, web pages may include input cells allowing the user to input user names, passwords or the like, using a keyboard, mouse or any other suitable user interface. According to the present embodiment, receipt number web page 134 includes an input cell allowing the client to input their DBD unique number. By inputting their unique number and sending this in electronic form in a request to server 2 via the Internet, the client may request a recommendation for further purchases that day.

Web page 134 includes an initial page allowing a user to enter their receipt number, and an example of the webpage 134 with input cell 90 for entering the DBD Unique number is shown in FIG. 6. As shown in FIG. 6, an icon 92 is provided labelled ‘send’ on which the client clicks with cursor 94 using their mouse after entering the DBD unique number. Before sending, the client may also indicate whether they are male or female by selecting the appropriate circle, 96 for a male and 98 for a female, as this will affect the recommendation. This information will be sent in electronic form to server 2.

It may be that a client has visited one of the chain of food outlets more than once recently, and wishes to request a recommendation based on more than one receipt DBD unique number. The webpage may be easily altered to include further input cells similar to cell 90 for inputting further DBD unique numbers. This data in electronic form would also be transmitted with the request.

Referring to FIG. 1, server 2 will receive the request including the electronic data representing the client's unique DBD number from the client terminal. Server 2 will then refer to database 10, and retrieve from this database the details, in electronic form, of the purchase (or purchases in the case of more that one DBD unique number), and in particular the unique product ids for each product. Any purchases that have an associated date and time more than 24 hours before the time of the request will be ignored, as the diet recommendation is designed to function over a 24 hour period. However, in alternative embodiments in which longer periods of time are used for the diet recommendation, then earlier purchases could also be considered. Server 2 will then pass this electronic data defining the product ids of purchases in the previous 24 hours to recommendation calculation unit 24 of FIG. 1. The recommendation calculation unit 24 will calculate a recommendation for further products that the user may purchase within the remaining 24 hours after their first purchase. This calculation is more detailed than the calculation provided for the receipts by unit 56. The result of this calculation will not only be to suggest to the client how many green, amber and red products they should eat in the remaining 24 hours, but will also provide menu suggestions.

The recommendation calculation unit 24 performs the calculation as follows. Unit 24 searches product database 26, and reads the entries in the product database associated with each product purchased defined by its unique product ID in electronic form. For each product sold in any of the food outlets, the product database will include electronic data entries providing, amongst other things, an indication as to whether the product falls within the category of red, amber or green. For example, the product database will have an electronic food value entry associated with the chicken sandwich indicating that it is an amber product, and a separate electronic food value entry associated with the green salad indicating that it is a green product. This electronic data associated with each purchased product will be accessed by the recommendation calculation unit 24. In an alternative embodiment the colour category of each purchased product could be transmitted from the service till at which the product was purchased and stored in database 10 associated with the unique DBD number of that purchase. In this alternative embodiment recommendation calculation unit 24 could access this information from database 10.

Having determined the colour category of each purchased product, the recommendation calculation unit then performs two functions. Firstly it will sum, preferably using adder circuitry, the number of red, green and amber products purchased. In the example above, a chicken sandwich, green salad and orange juice were purchased, and therefore the summed totals would be zero red products, one amber product, and two green products. If further products had been purchased at a different time in the previous 24 hours and the DBD unique number from a receipt for these purchases is entered in the recommendation request, then details of these purchases would be retrieved from database 10, and the colour values included in the totals.

The recommendation calculation unit will then refer to the electronic data stored in the daily allowance database 28, which lists the recommended numbers of red, amber and green products that should be eaten in a 24 hour period for males and females. The recommendation calculation unit 24 will refer to the correct electronic data stored in the database for a man or a woman, depending on whether the client selected circle 96 or 98 of FIG. 6. The recommendation calculation unit will compare the sum totals for purchased products of each colour red, amber and green with the daily allowance database values. This comparison will allow the recommendation calculation unit to determine whether or not the client is lacking green, amber or red products that day, and if so which products are needed.

In the example above, the sum of the green, amber and red products purchased, compared to the recommended daily numbers, will indicate that another two green, one amber and two red products would bring the client to his daily recommended number according to the traffic light system, assuming that the client is male. The result of this comparison is preferably also transmitted for display to the client along with recommended products as explained below.

The recommendation calculation unit would then use the result of the comparison to select products from the product database in order to generate the recommendation to the client. For example, given that having purchased two green products a further two green products are required to meet the recommended total number of green products, the recommendation calculation unit would search the product database for products with a food value equal to green for recommendation to the client. In this example, as green, amber and red products are all needed to bring the customer to their recommended levels, all green, amber and red products from the database will be selected. If, on the other hand, the customer had already purchased four green products in the previous 24 hours, then no green products would be recommended to the client.

Products in the product database 26 may only be available at certain times during the day. For example, croissants may only be available between 8 am and 10 am. This information, in electronic form, can be stored in product database 26 in association with each product, and products which are not available at the time of the recommendation request may not be included in the recommendation to the client.

The recommendation calculation unit 24 selects the appropriate products from the product database, and transmits to the client the indication, in electronic form, of what they could eat via server 2 and Internet 12. The indication could include various information taken from the product database, for example the product ids, as well as the names of the products, and details of the nutritional properties of the products. The recommendation will also provide the client with the time and date of the purchase or purchases.

Whereas the customers receipt indicated the recommended number of green, amber and red products that should be purchased based only on the purchases made shown on that receipt, a new calculation has now been performed by the recommendation calculation unit based on all the purchases made by the client in the past 24 hours (provided all receipt numbers were entered). Therefore, preferably the recommended number of green, amber and red products that should be eaten based on all product purchases in the previous 24 hours is now also transmitted to the client terminal so that this can be displayed to the client.

The client is then free to return to one of the food outlets to purchase one of the recommended meals. Alternatively, the client may order meals online. As will be described with reference to FIG. 7, the web page will include ordering means allowing the client to select the products he wishes to order, and by entering credit card details and his address, he may request the items to be delivered to his home or office.

As shown in FIG. 9c, receipt web page 134 includes a link to a dietary preferences and conditions page 124. This page allows a user to change their preferences and conditions in order for the system to provide a recommendation better matched to the user. As explained above, the daily allowance database 28 includes not only information regarding the recommended number of green, amber and red products for a 24 hour period, but also information regarding the allowances for people with medical conditions and preferences. These allowances may be used when producing the recommendation to the client if the clients preferences and conditions are known. Having already received the details of products recommended based on the traffic light system, the user may now enter further details in order to refine the recommendation to their preferences and conditions. The recommendation operation by the recommendation calculation unit 24 would then be repeated for a user, based on their preferences and conditions as well as their prior purchases.

After a client has entered their preferences and conditions at a client terminal, these details would be sent to server 2 in a new recommendation request. Again, the details of the purchased products would be retrieved from database 10, and provided to the recommendation calculation unit 24, along with the preference and condition data in electronic form. When preferences and conditions are known, the traffic light system is preferably still used in order to ensue the correct fat, sugar, salt and fruit and vegetable quantities are eaten, however depending on the preferences and conditions, the numbers of red, amber and green products may change, and the type of product within each category which is recommended may vary. For example, if a user indicates that they are diabetic and male, the number of red products that should be eaten in a 24 hour period may be reduced to one. In alternative embodiments, the daily allowance database 28 could include individual fat, sugar, salt and fruit and vegetable recommended quantities, and these values could be used to select products for the recommendation in conjunction with or in place of the traffic light system.

As explained above, the daily allowance database includes further nutritional information, for example the recommended quantities of certain vitamins, minerals, iron, fat, GI, fibre, omega 3 fatty acids, isoflavones, carbohydrate and protein for each of the combinations of preferences and conditions that could be selected by the user. For example, if a user selects the preference of having a low fat diet and specifies that they are diabetic, then the recommended allowances for carbohydrate and protein may be higher, and recommended allowance for fat and sugar would be lower. Based on these recommended quantities, as well as the recommended numbers of green, amber and red products according to the traffic light system, new products can be selected from the product database.

The calculation performed by the recommendation calculation unit 24 would be similar to the calculation described above for the recommendation based solely on the traffic light system. The recommendation unit will compare the daily allowances to the sum of the food values of products already purchased. For each of these comparisons the unit effectively subtracts the electronic data representing the sum of certain nutritional elements from the daily recommended value for those elements, to determine a data value representing the required remaining value for that day. For example, it may determine that, amongst other things, a further 2 green products are required, that the user has already met or exceeded their recommended daily quantity of iron and requires a further 1 gram of omega 3 fatty acids. The recommendation unit would then search the product database 26 and compare the nutritional values for each product with the result of the above comparison.

Unit 24 will recommend to the user products that meet the requirements. To do this it will compare the data for each product in the required category with the required nutritional values resulting from the comparison described above. For example it may choose a fish product in order to provide the client with additional omega 3 fatty acids if the fish product in the database indicates that the product contains a reasonable quantity. It may also choose stir fried vegetables for example, providing a further one or two green products. It may also select sugary desserts providing the user with red products to choose from. It would not however select products containing iron if the daily recommended iron values based on the preferences and conditions of the user had already been met or exceeded. If the client had already consumed three quarters of their daily fat allowance, then only low fat products would be selected.

It is likely that the recommendation based on preferences and conditions would select fewer products for recommendation to the user than using the traffic system alone, as more criteria is used to make the selection.

The client may own a mobile device depicted as mobile device block 20 in FIG. 1. The client mobile device may have access to the Internet via WAP (Wireless Application Protocol), or GPRS (General Packet Radio Service). Such access would be via mobile network 22. Using these connection services, the client is able to request a recommendation based on his DBD unique ID in a similar fashion as described in relation to the client terminal. Again recommendation calculation unit 24 would respond to the client's request and send a recommendation via server 2 and the Internet to the client's mobile device. The recommendation in this case might not include images of products which would be hard to display on the mobile device, and the number of products selected could be in some way limited so that the files are not too big to be downloaded.

In a second embodiment of the present invention, clients are issued with a personal ID card as shown in FIG. 5. Each ID card 70 is associated with a unique client ID number 74, in this case 480152. The card 70 may include a magnetic strip 72, and/or a microchip 76. The storage means 72 and 76 store the client ID in electronic binary form. They may also include further details of the client, for example the client's address. The client may be issued with a card at any of the food outlets, or alternatively the client may order a card via the Internet. This card could also function as a loyalty card. If the system described was implemented in a chain of supermarkets, loyalty cards already issued for customers of the supermarket chain could be used as the client ID card in embodiments of the invention.

The client ID card, and specifically the unique client ID number, allows client purchases to be linked to the client, and using information regarding the client stored in a database 10 shown in FIG. 1, recommendations may be sent to the client without the need for the client to request the information or to enter the purchase DBD unique numbers.

The use of the unique client ID card will now be described with reference to FIGS. 1, 2 and 3.

Supposing a client who has been issued with an ID card enters for example, one of the chain of food outlets in order to purchase breakfast. The client buys a croissant in packaging 60 with barcode 62, which has packaging coloured red indicating that this is a high fat product. The client also purchases a cup of tea packaged in cup 64 with barcode 66. The client takes these purchases to a service till, where a member of staff is ready to serve him. At the same time as handing over the products to be purchased, the client hands over his unique ID card 70.

As described in the previous embodiment, the staff member will pass each of the products to be purchased by the client under the barcode scanner 40 shown in FIG. 2. In this way the data stored in the barcodes on each item can be read and the data inputted in electronic form to the service till processor 30. Service till processor 30 will then refer to memory 32 to determine the nature and price of each item. Also as described in relation to the previous embodiment, memory 32 stores a database containing all of the products for sale in the food outlet that are part of the traffic light system. Associated with each item in the database is also a unique ID for each product. Processor 30 will sum the cost of the individual products using information provided from memory 32, and indicate to the staff member via staff interface 36 the total cost of the purchase.

The member of staff will request payment from a client, and will enter the payment method using keypad 38. As described in the previous embodiment, payment receiving unit 42 may be a credit card reader, or cash register or both, and will be used by the member of staff to take payment.

The member of staff will then indicate to the service till processor 30 that the client has a unique ID card, via keypad 38. Service till processor 30 will request via the staff interface 36 that the magnetic card is swiped through the magnetic card reader 44 shown in FIG. 2. In this way the information stored on the magnetic card is read, and if necessary decoded by the magnetic card reader and sent in electronic form to the service till processor 30. As described in relation to FIG. 5, the unique client ID card 70 may alternatively use a microprocessor chip 76 to store the information. In this case an alternative reading mechanism would be used to read the information from the client card. Alternative information storage means may be used on the client card 70, and alternative readers may be used in order to extract this information.

Service till processor 30 then creates a record of the purchase associated with the client's ID number, which lists in electronic form each of the purchases with each product's unique ID number, and also indicates the time and date of the purchase in electronic form. This information will be stored in a record in memory 32. This information will also be transmitted in the form of electronic data to the main server 2 shown in FIG. 1 via interface 48. The information may be transmitted to server 2 directly the purchase has been made, or alternatively server 2 may request from time to time information relating to recent purchases from service till processor 30 via interface 48.

A colour based recommendation for products may be provided to the client on his receipt, by passing the number of each green, amber and red product purchased to calculation unit 56. The process will be the same as in the previous embodiment, except that the receipt will print the clients ID number on the receipt rather than the unique DBD number.

Advantageously according to the present embodiment, server 2 stores the information relating to the client's purchase in database 10. If the client then enters another of the food outlets, then information regarding further future purchases may also be stored in database 10 via server 2, and be associated with the same user.

As shown in FIG. 2, the shop terminal may also include a magnetic card writer 46. This could for example allow details of the purchase including the unique ids for each purchase item to be recorded on the magnetic strip or the client's ID card. This could also be used for generating new ID cards when a new client without an account makes a purchase. A new client ID number may then be generated by service till processor 30 in a similar fashion to the generation of the unique DBD number described in the previous embodiment, and this number written to a new card in binary form and magnetic card writer 46.

Information regarding the client's purchases stored in database 10 may be used in a number of ways. Firstly, as described in the previous embodiment the client may have access to a computer terminal as shown in FIG. 1 as the terminals labelled 14, 16, 18. Via the client terminal the client may access the Internet and as described in the previous embodiment, the client may request a recommendation for meals in the remaining 24 hours after his purchase. Again the client may request the recommendation via a web page. Referring to FIG. 7, this page would be accessed by the client signing in to the members area via the sign in page 144 if they have a full account, or page 142 if they have an anonymous account, and these pages will be described in more detail below. The sign in page would request the clients unique ID number, and the client would enter their unique ID number 74 as written on their ID card. By then clicking a box with a computer mouse, electronic data representing the clients ID number can be transmitted to the server 2. The system is arranged to automatically generate the request to the server 2 for a recommendation based on any recent purchases, for presentation to the client. In the current example the client's ID number is 480152, and therefore this ID number would be entered into the input cell on the sign in web page.

Upon receiving the electronic data representing the client's request, server 2 will refer to the database 10 and retrieve the information regarding the client's purchases in the previous 24 hours. The information in the database will indicate that the client that morning purchased a croissant, and a cup of tea, and the purchase will have a date and time. Server 2 will then provide this data to recommendation calculation unit 24 in order to generate the recommendation.

Advantageously according to this second embodiment, preferences and conditions may be stored regarding the user, and these details may be referred to every time a recommendation is generated, when determining the daily allowances for the client. Ideally when opening an account the client will specify personal information such as their preferences, medical conditions, gender, etc. This information would be entered on web page 124 of FIG. 7, and will then be stored in database 10 associated with the clients ID number. When a recommendation is requested by the client, server 2 will retrieve this information from database 10, and this may then be passed to recommendation calculation unit 24. When accessing the recommended daily allowances from database 28, this personal information may then be used find the correct values from the database.

Thus, using this detailed information regarding the client, the appropriate allowance values can be extracted from allowance database 28, and compared to the sum of the values of the purchased items. Using this comparison, the recommendation calculation unit will then select products from product database in order to provide the client with a balanced diet. This calculation of the recommendation by the recommendation calculation unit 24 will be the same as described in relation to the DBD unique number embodiment described above when the user specified preferences and conditions. The only differences is that in this embodiment the preference and conditions data is stored in database 10 associated with the client, and does not have to be entered by the client for each recommendation. The recommendation will be transmitted to the client terminal for display to the client, and as in the previous embodiment, it may include images of the products, prices etc.

Alternatively or additionally, server 2 may be programmed to transmit recommendations to a client terminal or to a client mobile device from time to time, without the client requesting this information specifically. In embodiments of the invention with this feature, the product database 26 preferably includes an indication associated with each product as to whether it is suitable for breakfast, lunch or dinner, as a main dish or desert. In this way, for example one hour after a breakfast purchase of the croissant and the tea, the server 2 may automatically pass the purchase details to the recommendation calculation unit in order to calculate a recommendation for lunch and dinner that evening. The recommendation would be generated in the same way as a requested recommendation, except that only products which are indicated as lunch or dinner products would be selected. General recommendations could also be passed to the client, for any products based only on recent purchases and their preferences and conditions, irrespective of whether the products are for breakfast, lunch or dinner. Database 10 will include information, in electronic form, such as the clients email address and mobile telephone number. Server 2 will request this data from database 10 when sending a recommendation to the clients e-mail address, for example, or their mobile telephone number. In this way recommendations may be passed to the client to their e-mail address, and/or via text or media message to their mobile device.

The plan of the web interface shown in FIG. 7 will now be described. Clients wishing to receive a recommendation based on a unique DBD number on their receipt, or to create a personal account or sign in to their account, can go to the web pages associated with the food outlet chain, which in the example is know as Flavour. The appearance and functionality of each page is not shown in FIG. 7 (some of these are shown in FIGS. 9a to 9e), however the linking structure is indicated as will now be described.

The first page that a client will access will be page 120, which is a homepage and will have a link to a daily balanced diet page 122. The daily balanced diet page provides a contents list linking to the other pages of the website, and each of the other pages will contain a link bringing the user back to this page. This link is indicated by the number 122 in an ellipse featured on all other pages.

The daily balanced diet page provides links to a page 132 showing the complete menu, the receipt page 134, the account sign in page 142, an account set up page 138, the diet preferences page 124 and an information page 130. For brevity the possible links from each page will not be described in detail.

The menu page 132 provides a complete listing of the menus. This page is shown in FIG. 9b, and as shown in that figure, red, amber and green products are shown with images of each product. Some products are starred and these products will only be available at a store or to purchase online between 7 a.m. to midday. From this page, an order form page 140 is accessible for ordering food products, and will include input cells for entering payment details etc. From this page it is also possible to enter a menu option details page 128, the diet preferences page 124 and account setup page 138, discussed in more detail below.

The receipt page 134 allows a client to enter their unique DBD number from their receipt in order to receive a recommendation, as discussed previously. As shown in FIG. 9c, upon entering one or more receipt numbers, the purchases made will be illustrated to the user. The recommended number of red, green and amber products will then be indicated to the user, based on all of their purchases. This can be calculated by recommendation calculation unit 24 as described above. Products are then indicated based on the previous purchases and recommended daily allowances, and these products are selected by recommendation calculation unit 24 as discussed above, and illustrated to the user. The user can then access the order form page 140 to order items, view menu details from page 128, set up an account on page 138 or enter dietary preferences and conditions on page 124.

As described in detail above, having received a recommendation based solely on their previous purchases a user may proceed from receipt page 134 to preference and conditions page 124 in order to refine the recommendation based on their preferences and conditions. Once preferences and conditions have been selected, a new recommendation request is automatically generated including the receipt numbers of the purchases, and transmitted to server 2. Recommendation calculation unit 24 may then generate the new recommendations based on previous purchases and on these preferences and conditions, as described above.

The account set up page 138 allows users to set up accounts. There are two types of accounts a user can set up, and in each case the user is issued with an ID card. The first type of account, Flavour 4 U, is an anonymous account set up by a user who has picked up an ID card from one of the food outlets, but does not wish to provide their personal information. These users may however enter their preferences and conditions on page 124, which will then be stored in database 10. These preferences and conditions allow personalised daily allowance values to be taken from the daily allowance database 28 when a recommendation is being provided. The second account, Full Flavour, allows users to open a full account in which they enter personal details such as their name, postal address, email address and mobile number, and again these details are stored in database 10 so that recommendations can be sent to them without them needing to make a request.

The account sign in page 142 allows users who already have Flavour 4 U accounts to sign into the system, and access recommendations. This page is shown in FIG. 9E, and once an account holder has signed in, recent purchases are automatically illustrated on the users screen, and a recommendation is automatically generated. From this page there is a link to a purchase history page which lists all purchases previously made by the user. There are also links to order form 140, menu option details page 128, full flavour sign in 144 and account setup page 138 in case they wish to change any of their personal details.

Customers with Full flavour accounts sign in on page 144, and as well as having access to all of the features on page 142, on this page they can also enter options and view details regarding automatic text alerts providing automatic recommendations to their mobile phone or email address, loyalty schemes, and new product information.

An example of menu details page 128 is shown in FIG. 9A. This page is linked to automatically when a product illustration is clicked on by a users mouse, and shows an ingredients list of the selected product, as well as nutritional information about the product, which is for example the same information as that stored in product database 26.

An example of Menu options page 136 is shown in FIG. 9D. This page is linked to from the diet preferences and conditions page 124, and give details of recommended products for certain medical conditions or preferences, and provides further information.

In embodiments of the present invention, no purchase is necessary in order to receive a product recommendation based solely on preferences and conditions indicated by a user on the preferences and conditions page. In this case, a user selects their preferences and conditions on page 124, and an electronic request is automatically generated at the user terminal and transmitted to server 2. A recommendation will then be generated by recommendation unit 24 as described previously, based on the recommended daily allowances for the preferences and conditions selected. However, in this case, as there has been no purchase, the product values provided to recommendation calculation unit 24 will be effectively zero, and therefore a greater range of recommended products will be indicated to the user in response to the request.

The fact sheet 126 provides information to the user regarding preferences or conditions selected by the user.

The information page 130 provides more information on the daily balanced diet.

In embodiments of the present invention, each service till processor 30 may also be connected to a remote customer interface 50 as shown in FIG. 2. One or more remote customer interfaces 50 may be located in each of the food outlets. Each remote customer interface 50 has associated with it a memory 52 and keypad 54 connected thereto. As described above, the remote customer interface includes a screen for presenting information to customers. The remote customer interface 50 may be used in either of the previous embodiments as will now be explained.

Remote keypad 54 of the remote customer interface 50 allows a client to enter one of either their daily balanced diet unique number from their receipt 80, or their unique ID number 74 from their ID card 70. Supposing that a client purchased that morning a number of items from one of the food outlets, the client returning at lunchtime may require a recommendation for the remaining 24 hours without requiring the use of a client terminal or a mobile device. The client may use the remote customer interface 50 located in one of the food outlets.

In order to use the interface, the client will enter into the keypad either the daily balanced diet unique number or their client id. Remote customer interface will then transmit this information in electronic form to service till processor 30. Service till processor 30 will check memory 32 in order to determine whether there are any recent purchases relating to this client associated with their client ID number or DBD unique number stored in memory 32. Ideally the DBD unique number and Client ID number have the same format so that the service till need not determine a difference. If nothing is found in memory 32, then this indicates that either the products from a previous client purchase were purchased at a different food outlet, or that the details of these purchases have now been forwarded to server 2 to be stored in database 10 of FIG. 1.

If entries are found in memory 32 associated with the client unique ID number or client DBD unique number, then the product ids associated with these numbers from memory 32 will be transmitted to server 2 via interface 48. In any case, electronic signals representing the client ID number or the DBD unique number will be transmitted to server 2, along with a request for a recommendation. As with the webpage example, the remote client interface 50 may request further information from a client, such as their gender, or any medical conditions or preferences, and this information can also be sent.

Server 2 will then check database 10 for purchases relating to the client ID number, or to the DBD unique number, and return the product ids and provide these to recommendation calculation unit 24. Server 2 will also provide the product ids of any products stored in memory 32 that have been transmitted from the service till processor 30, and any information entered by the client relating to their gender, medical conditions or preferences. As described in previous embodiments, the recommendation calculation unit will then use the product's ids with the product database and daily allowance database in order to prepare a recommendation for the client. The recommendation will be returned to the remote client customer interface at the food outlet via the server 2, interface 48 and service till processor 30. At the remote customer interface 50, the recommendations will be stored in memory 52, and displayed on a screen to the client.

FIG. 10 illustrates a flow chart of operation of one particular implementation of an embodiment of the invention, where it is assumed that the products are colour coded gold, silver and white. According to step S1, the barcode 62 of the product 60 is scanned at the point of purchase. In addition, the ID card or loyalty card 70 is scanned to record the purchase against the loyalty card 70.

At step S2, the purchase is recorded by the central system and a receipt is issued. At step S3 the customer profile is updated with the purchase and this information is fed to a terminal which hosts the website. Step S4 illustrates a customer logging on with their loyalty card to the website. The website is then prompted to display a first screen which reads:

“Hello Mrs Smith

You have purchased 1×gold—you have 2×silver and 2×white left to consume by . . . ”.

The information for the dotted line is completed by ascertaining the period within which the remaining products should be consumed. In the embodiment described herein, this is 24 hours.

The website then moves on to display a screen which reads:

Silver and white dishes that match your requirements are . . . ”.

The missing information is completed by a list of menu dishes within the colour grades remaining that suit the preselected preferences and conditions of the user, as described above.

In the embodiments of the present invention described previously, the service till processor 30 has been described as being operated by a member of staff. However, in alternative embodiments, the service till processor could be self service. In this case the client might pass the barcode of the product past the barcode scanner 40 themselves, and perform the other roles described as being performed by the member of staff, such as swiping their id card through the card reader when prompted. In this case, the staff interface 36 would be altered to form a client interface, with client keypad.

In an alternative embodiment of the present invention, the colour categorised food products could be available from vending machines. In this case, a suitable interface would be required to allow the client to make a selection, provide payment etc. This would replace or incorporate features of the shop terminal 4. Having made a selection, it would not be necessary for a barcode of the product to be scanned, as the selection made by the client would indicate to the machine which product had been purchased, and therefore the product reference would be known for use in embodiments of the invention described above. In this embodiment it may not be necessary to look up the colour of each item based on its reference number, as the location of the product could indicate the colour of the product directly.

The application hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A system for generating for a client at least one indication of a food product to be purchased, the system comprising:
data entry means for entering at least one product reference associated with a purchased product;
first storage means for storing said at least one product reference in association with an identifier;
second storage means for storing a plurality of product references in association with respective food values;
third storage means for holding a recommended total food value;
terminal means coupled to the first storage means for receiving the identifier;
a recommendation unit for comparing the food value of the purchased product with said recommended total food value, said recommendation unit being arranged to select from said plurality of product references at least one product based on the result of said comparison, whereby said indication is generated for the client.

2. The system as claimed in claim 1, wherein the recommendation unit further comprises:
means for receiving said at least one product reference from said first storage means;
means for reading from said second storage means food values associated with said product reference; and
means for reading from said third storage means the recommended total food value.

3. The system as claimed in claim 1, wherein the recommendation unit further comprises:
means for determining the difference between the food value of the purchased product and said recommended total food value; and
means for reading from said second storage means at least one product with an associated food value less than or equal to said difference.

4. The system as claimed in claim 1, wherein the identifier is associated with the purchase of one or more products.

5. The system as claimed in claim 1, wherein the identifier is associated with the client.

6. The system as claimed in claim 3 wherein the identifier is associated with a client account.

7. The system as claimed in claim 6 further comprising storage means for storing personal information associated with the client.

8. The system as claimed in claim 1 wherein the food products are organised in a set of categories, each category including food products of a food type.

9. The system as claimed in claim 8 wherein the food type is indicated by colour.

10. The system as claimed in claim 1 wherein the food value indicates a nutritional content.

11. The system as claimed in claim 1 wherein the recommended total food value in the third storage means is associated with a client type.

12. The system as claimed in claim 1 further comprising display means for displaying said indication.

13. The system as claimed in claim 1 comprising a computer network having:
server mean including said recommendation unit; and
at least one store terminal connected to said server means, said store terminal including said data entry means.

14. The system as claimed in claim 13, wherein said terminal means comprises a client terminal remote from said store terminal and connected to said server means.

15. A system for generating for a client at least one indication of a food product to be purchased, the system comprising:
data entry means for receiving a food type associated with a purchased product, said food type representing a food value;
storage means for holding a recommended total food value;
a calculation unit for comparing the food value of the purchased product with said recommended total food value, said calculation unit being arranged to indicate at least one food type based on said comparison; and
printing means for printing said at least one food type on a receipt for the client.

16. Server circuitry for generating for a client at least one indication of a food product to be purchased, the server circuitry comprising:
means for receiving at least one product reference associated with a purchased product;
first storage means for storing said at least one product reference in association with an identifier provided to the client;
second storage means for storing a plurality of product references in association with respective food values;
third storage means for holding a recommended total food value;
receiving means for receiving an identifier from a remote terminal, and for accessing the purchased product associated with that identifier;
means for comparing the food value of the purchased product with the recommended total food value and selecting from said plurality of product references at least one product based on the result of said comparison, thereby generating said indication for the client.

17. A terminal for providing to a client at least one indication of a food product to be purchased, the terminal comprising:
input means for inputting an identifier provided to said client;
transmitting means for transmitting said identifier to server circuitry; and
receiving means for receiving from said server circuitry said at least one indication and providing said indication to the client, wherein said server circuitry is operable to:
receive said identifier;
determine at least one product reference associated with said identifier;
determine a food value associated with said at least one product reference;
compare said food value with a recommended total food value, and based on said comparison select from a plurality of product references at least one product; and
transmit said indication indicating said at least one product.

18. A shop terminal for transmitting product references to server circuitry, such that said server circuitry is able to generate for a client at least one indication of a food product to be purchased, the shop terminal comprising:
data entry means for entering at least one product reference associated with a purchased product; and
means for transmitting said at least one product reference to said server circuitry, wherein said server circuitry is operable to:
store said at least one product reference in association with an identifier;
determine a food value associated with said at least one product reference;
compare said food value with a recommended total food value, and based on said comparison select from a plurality of product references at least one product, whereby said indication is generated for the client.

19. A method for generating for a client at least one indication of a food product to be purchased, the method comprising the steps of:
at a first location, receiving at least one product reference associated with a purchased product; and
storing said at least one product reference in association with an identifier;
and at a second location receiving the identifier from terminal means;
determining a food value associated with the purchased product;
determining a recommended total food value;
comparing the food value with the recommended total food value; and
selecting from said plurality of product references at least one product based on the result of said comparison, thereby generating said indication for the client.

20. A method for generating for a client at least one indication of a food product to be purchased, the method comprising the steps of:
inputting an identifier at a client terminal;
transmitting said identifier to server circuitry; and
receiving from said server circuitry said at least one indication, wherein said server circuitry is capable of:
receiving said identifier;
determining at least one product reference associated with said identifier;
determining a food value associated with said at least one product reference;
comparing said food value with a recommended total food value, and based on said comparison selecting from a plurality of product references at least one product; and
transmitting said indication indicating said at least one product.

21. A method for generating for a client at least one indication of a food product to be purchased, the method comprising the steps of:
inputting at least one product reference associated with a purchased product; and
transmitting said at least one product reference to server circuitry, wherein said server circuitry is capable of:
storing said at least one product reference in association with an identifier;
determining a food value associated with said at least one product reference;
comparing said food value with a recommended total food value, and based on said comparison selecting from a plurality of product references at least one product, whereby said indication is generated for the client.

22. A system for generating for a client at least one indication of a food product to be purchased, the system comprising:
first storage means for storing a plurality of product references in association with respective food values;
second storage means for holding a plurality of recommended total food value;
terminal means for receiving preference and/or condition data relating to said client and transmitting said preference and/or condition data to a recommendation unit;
said recommendation unit arranged to determine a recommended total food value associated with said preference and/or condition data and compare said recommended total food value with food values associated with said product references, said recommendation unit being arranged to select from said plurality of product references at least one product based on the result of said comparison, whereby said indication is generated for the client.

23. A terminal for providing a client at least one indication of a food product to be purchased, the terminal comprising:
input means for inputting preference and/or condition data relating to said client;
transmitting means for transmitting said preference and/or condition data to server circuitry; and
receiving means for receiving from said server circuitry at least one indication and providing said indication to the client, wherein said server circuitry is operable to:
receive said preference and/or condition data;
determine a recommended total food value associated with said preference and/or condition data;
compare said recommended total food value with food value associated with a product, and based on said compensation select from a plurality of product references at least one product; and
transmit said indication indicating said at least one product.

24. A method for generating for a client at least one indication of a food product to be purchased, the method comprising the steps of:
inputting at least one preference or condition associated with said client; and
transmitting said at least one preference or condition to server circuitry, wherein said server circuitry is capable of:
determining a recommended total food value associated with said preference or condition;
determining at least one food value associated with said at least one product reference;
comparing said recommended total food value with said at least one food value, and based on said comparison selecting from a plurality of product references at least one product, whereby said indication is generated for the client.
